(19) United States
(12) Patent Application Publication
(10) Pub. No.: US 2008/0281903 A1
(43) Pub. Date: Nov. 13, 2008

(54) System and method for providing interactive multimedia content

(76) Inventor: Marek Kwiatkowski, Swietochlowice (PL)

Correspondence Address: MCDERMOTT, WILL & EMERY LLP, 227 WEST MONROE STREET, SUITE 4400, CHICAGO, IL, 60606-5096, US

(21) Appl. No.: 11/801,520

(22) Filed: May 10, 2007

(51) Int. Cl. G06F 15/16

(52) U.S. Cl. 709/203

(57) ABSTRACT

A system for providing interactive multimedia content includes an electronic device having a unique identification and an personalized content profile associated therewith. The electronic device includes an input device that receives data input by the user, a transmitter that transmits data, including data input by the user, to a provider system, a receiver that receives encoded multimedia content from the provider system and an output device that provides decoded multimedia content to a user. The electronic device further includes one or more controllers that control the operation of the input device, the transmitter, the receiver and the output device. The controllers decode the encoded multimedia content and output the decoded multimedia content through the output device. The decoding and output is based, at least in part, on the device's personalized content profile.

### TECHNICAL FIELD

The disclosed embodiments relate generally to a system and method for providing interactive multimedia content. More specifically, the present subject matter relates to a system and method for providing interactive content wherein multimedia providers can identify unique users, provide targeted and/or customized multimedia content, and collect information regarding usage.

### BACKGROUND

It may be beneficial for a multimedia content provider or a plurality of multimedia content providers to be able to associate the content provided with an identified user or associated electronic device. For example, it may be useful to obtain information regarding a user's use of phone, radio, television and internet services, including the fact that the content was accessed, who accessed the content, when the content was accessed, what content was accessed, how the content was accessed (menu structure, hyper-linking, etc.), the time each request or usage occurred (start of content delivery, switching of channel or other content selection mechanism, end of content delivery, etc.), payment mechanism utilized, etc. The information gathered may be useful in customizing content delivery based on a user's preferences, providing feedback to producers, programmers, advertisers, etc. Similarly, users may benefit from personalized media content.

Although individual media providers are able to track some of the information listed above to various extents, there has not been a platform that allows for the complete identification of each user and each user's usage, regardless of the whereabouts and medium used to access the content.

One problem associated with existing transmission media is the limitations of broadcast, unicast and multicast transmissions. Broadcast transmission does not lend itself to interactive content and collecting information about users. Unicast transmission requires separate connections from each user to the content provider. Therefore, transmitting content to a large number of users limits the output capability of the system. However, unicast systems are able to identify each user as unique, for example by identifying an IP address for each user. By contrast, multicast transmission does not require a high capacity transmission network, but can not uniquely identify each user.

Therefore, a need exists for a real-time system and method wherein multimedia providers can identify unique users, provide targeted and/or customized multimedia content and collect information regarding usage.

### SUMMARY

The above and other needs are met by the disclosed embodiments which provide an electronic device that provides multimedia content to a user. The embodiments provided herein allow users to access multimedia content, including services, information, entertainment, shopping, telecommunication services (e.g., internet, telephone, etc.), via an electronic device (e.g., television, computer, phone, smart phone, etc.) using a communication network (e.g., antenna, cable, DSL, satellite, wireless, cellular, sms, etc.). The solutions provided herein may enable a user to interactively participate in quizzes, movies, lotteries, auctions, promotions, shopping, advertising, personalization of their multimedia content, pay-per-use multimedia content (e.g., movies, sports programming, entertainment, etc.), previews, ticket purchasing, reservations, etc. The solutions provided herein may further enable service/content providers to target users for personalized advertising, promotions, surveys, questions, classifieds, etc. and also enable direct contact with the users.

In one example, an electronic device has a unique identification and an personalized content profile associated therewith. The electronic device further includes an input device that receives data input by the user, a transmitter that transmits data, including data input by the user, to a provider system, a receiver that receives encoded multimedia content from the provider system and an output device that provides decoded multimedia content to a user. The electronic device further includes one or more controllers that control the operation of the input device, the transmitter, the receiver and the output device. The controllers decode the encoded multimedia content and output the decoded multimedia content through the output device. The decoding and output is based, at least in part, on the device's personalized content profile.

In another example, a computer-readable medium having computer-executable instructions for providing interactive multimedia content using a controller in an electronic device, the computer-executable instructions performing the steps of: transmitting unique identification data and data input into the electronic device by the user to a provider system; receiving, in the controller, encoded personalized multimedia content from the provider system, wherein said personalized multimedia content is based, at least in part, on said data input by the user; decoding, in the controller, said encoded personalized multimedia content; providing, via the electronic device, said decoded personalized multimedia content to the user; collecting data regarding the user's activity with respect to the multimedia content; and transmitting said data collected to said provider system.

In yet another example, a method of providing interactive multimedia content via an electronic device that has a unique identification and an personalized content profile associated therewith. The method includes the steps of: transmitting the unique identification and data input into the electronic device by a user to a provider system; receiving, in the electronic device, encoded multimedia content from the provider system, wherein the multimedia content is based, at least in part, on said data input by the user; decoding the encoded personalized multimedia content; providing, via the electronic device, said decoded personalized multimedia content to the user, wherein the decoding is based, at least in part, on the personalized content profile; collecting data regarding the user's activity with respect to the multimedia content; associating the collected data with the electronic device's unique identification and transmitting said data collected to said provider system.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic of a system for providing interactive multimedia content.

FIG. 2 is a method for providing interactive multimedia content.

### DETAILED DESCRIPTION OF THE PREFERRED EMBODIMENTS

It is contemplated that the subject matter described herein may be embodied in many forms. Accordingly, the embodiments described in detail below are the presently preferred embodiments, and are not to be considered limitations.

The disclosed embodiments address problems related to providing interactive multimedia content. The disclosed embodiments solve these problems, at least in part, by utilizing an electronic device that provides multimedia content to a user. The electronic device has a unique identification and an personalized content profile associated therewith. The electronic device further includes an input device that receives data input by the user, a transmitter that transmits data, including data input by the user, to a provider system, a receiver that receives encoded multimedia content from the provider system and an output device that provides decoded multimedia content to a user. The electronic device further includes one or more controllers that control the operation of the input device, the transmitter, the receiver and the output device. The controllers decode the encoded multimedia content and output the decoded multimedia content through the output device. The decoding and output is based, at least in part, on the device's personalized content profile.

The earlier stated needs and others are met by still other disclosed embodiments that enable a computer-readable medium having computer-executable instructions for providing interactive multimedia content using a controller in an electronic device, the computer-executable instructions performing the steps of: transmitting unique identification data and data input into the electronic device by the user to a provider system; receiving, in the controller, encoded personalized multimedia content from the provider system, wherein said personalized multimedia content is based, at least in part, on said data input by the user; decoding, in the controller, said encoded personalized multimedia content; providing, via the electronic device, said decoded personalized multimedia content to the user; collecting data regarding the user's activity with respect to the multimedia content; and transmitting said data collected to said provider system.

The earlier stated needs and others may further be met by a method of providing interactive multimedia content via an electronic device that has a unique identification and an personalized content profile associated therewith. The method includes the steps of: transmitting the unique identification and data input into the electronic device by a user to a provider system; receiving, in the electronic device, encoded multimedia content from the provider system, wherein the multimedia content is based, at least in part, on said data input by the user; decoding the encoded personalized multimedia content; providing, via the electronic device, said decoded personalized multimedia content to the user, wherein the decoding is based, at least in part, on the personalized content profile; collecting data regarding the user's activity with respect to the multimedia content; associating the collected data with the electronic device's unique identification and transmitting said data collected to said provider system.

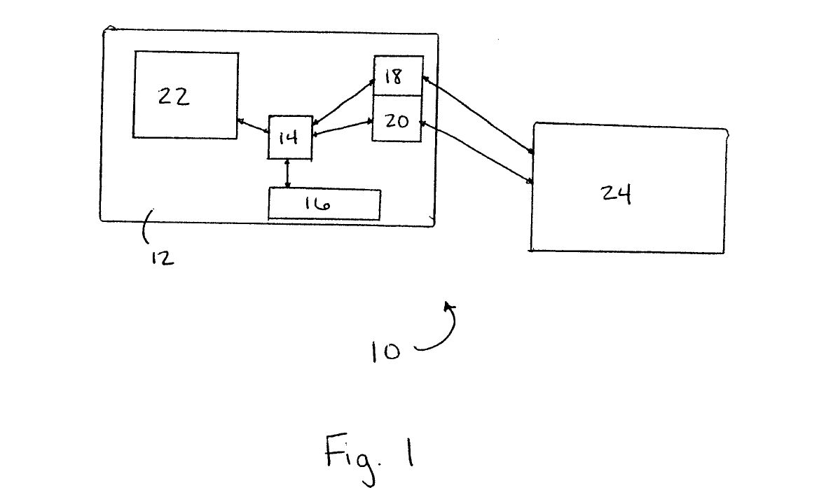

FIG. 1 illustrates a system for providing interactive multimedia content 10 in which an electronic device 12 includes a controller 14 that controls an input device 16, a transmitter 18, a receiver 20 and an output device 22. The controller 14 is programmed to enable the electronic device 12 to receive encoded multimedia content from a provider system 24 while concurrently transmitting the user's identity and data input by the user to the provider system 24. As used in the examples provided herein, the controller 14 may be a hardware component or a software component. For example, in one example, the controller 14 may be software programmed on a flash drive for controlling the electronic device.

In the example shown in FIG. 1, the electronic device 12 is a television with the controller 14 integrated therein. However, it is understood that the electronic device 12 may be a television with a set-top-box that integrates the controller 14 to the operation of the television. It is further contemplated that the solutions provided herein may be accomplished with any electronic device 12 or combination of electronic devices 12. For example, the electronic device 12 may be a computer, a cellular phone, a smart phone, a personal digital assistant, an electronic audio and/or video device, such as an MP3 player, an electronic token or any other electronic device 12.

As described above, the electronic device 12 includes a controller 14. The controller 14 is described in greater detail below. However, generally and typically, the controller 14 is an integrated circuit including a central processing unit (CPU), input/output interfaces, other communication interfaces, memory, a clock generator and one or more peripherals. It is contemplated that the controller 14 used to accomplish the solutions provided herein may be embodied in one or more controllers 14. Accordingly, any use of the term controller herein is understood to refer to one or more controllers 14.

The controller 14 may be embedded in the electronic device 12. In the solution shown in FIG. 1, the controller 14 may be a microcontroller embedded in a television. In another solution, the controller 14 may be a microcontroller embedded in a smart phone. Accordingly, the controller 14 may be responsible for managing and controlling the operation of the electronic device 12 in which it is embedded. However, in the solutions provided herein, the controller 14 is primarily responsible for unique identification data and managing, controlling and administering data transfers between the electronic device 12 and the provider system 24, as will be described in further detail below.

As noted above, the controller 14 may be responsible for managing, controlling and administering unique identification data. Unique identification data may be any data used to uniquely identify an electronic device 12 or a user to the provider system 24. For example, the unique identification data may be an encrypted code. It is further understood that the unique identification data may be any other data used to uniquely identify an electronic device 12 or a user, such as, for example, a password, biometric information, challenge responses, etc. The unique identification data may be used by the provider system 24 to identify a particular electronic device 12 or user for purposes of providing personalized multimedia content and/or for collecting data as described further below.

In a contemplated solution, the unique identification data is associated with the electronic device 12. However, in many contemplated solutions the electronic device 12 may be used at various times by a plurality of users. Accordingly, the electronic device 12 may include unique identification data for each user thereby enabling the data provided to the electronic device 12, and collected from the electronic device 12, by the provider system 24 to be linked to each user account. As a result, users may be required to log on to the electronic device 12 in order to access their personalized multimedia content and to ensure the data is correlated with the correct user. In some contemplated solutions, the log-in process may occur automatically using biometric or other automatically collected information.

Moreover, the unique identification data may be associated with an individual user or a user group. For example, in a household where four users each utilize a given electronic device 12, each user may have an individual user account and there may be additional accounts for various combinations of the four users, e.g., a separate profile may be established for when the four users are all watching the television. In the solutions wherein a given electronic device 12 includes unique identification data for a plurality of users or user groups, the unique identification data may be associated to secured or unsecured log-in data. For example, after a secure log-in sequence is completed within the electronic device 12 a unique user code may be transmitted from the electronic device 12 to the provider system 24.

In the example shown in FIG. 1, the input device 16 is a remote control for controlling the electronic device 12 (i.e., television). However, it is understood that the input device 16 may be any input device 16 appropriate for interacting with the electronic device 12, including, for example, a touch screen, a keypad, a keyboard, a mouse, a voice command recognition device, biometric input device, etc. The input device 16 enables the user to operate the system 10, including, for example, the electronic device 12 and interacting with any electronic content guides or other services provided by the provider system 24. The input device 16 may be any number of devices or mechanisms by which a user can input data into the system 10. Further, the input device 16 may receive as input data actively input by the user (e.g., channel selection), as well as data passively input by the user (e.g., the time the channel is changed). Moreover, the input device 16 may include one or more condition sensing mechanisms that collect information regarding the user's activity, location, the current time, etc., without requiring any activity or input from the user.

The transmitter 18 and the receiver 20 shown in FIG. 1 are both embodied in the electronic device 12 (e.g., television), which is able to communicate through a packet switching network utilizing Internet protocol (IP). For televisions that are not IP enabled, a set top box may be utilized to provide IP functionality. IP is a preferred communication protocol because it is presently a common protocol and provides adequate transmission and security functionality. The use of IP enables a user to access the user's personalized multimedia content through any system that utilizes IP communications as long as the user is able to provide the unique identification data. IP enables bilateral communication whereby the provider system 24 can provide multimedia content to the user while the electronic device 12 transmits data back to the provider system 24. Additionally, IP makes it possible for the provider system 24 to identify the user's network, user's location, the date and the time. However, it is contemplated that other communication platforms may be utilized. For example, and not as a limitation, session initiation protocol (SIP), subscriber identity module (SIM), global system for mobile (GSM), and universal mobile telecommunication system (UMTS) protocols may be used, enabling the personalized multimedia content to be provided via televisions, computers, personal digital assistants, cellular phones, etc. Further, the transmitter 18 and receiver 20 may be separate devices or may utilize separate communication platforms or protocols. The operation of the transmitter 18 and the receiver 20 is controlled by the controller 14. The controller 14 may be further responsible for decoding the multimedia content before providing the data through the output device 22.

The output device 22 shown in FIG. 1 is embodied in the audio speakers and video screen of the electronic device 12 (e.g., television). Alternatively, the output device 22 may be any output device appropriate for delivery of multimedia content to a user. For example, multimedia music content may be provided through the output of an electronic music player, such as, for example, an MP3 player.

The provider system 24 shown in FIG. 1 is a multimedia content provider system. The provider system 24 includes computer systems for storing multimedia content, providing multimedia content to users and receiving data transmitted from user's electronic devices 12.

In the embodiment of the system 10 for providing interactive multimedia content shown in FIG. 1, an electronic device 12 or a user is identified to the provider system 24 using unique identification data. After the user has been identified, personalized multimedia content can be provided to the user's electronic device 12. The multimedia content can be personalized based on data provided to the provider system via the input device 16. The personalization may take into account any information including, for example, the user's country of origin, region, district, viewing habits, sex, age, education, profession, orientation, religion, language, the user's specific interests in sports, tourism, culinary arts, politics, hobbies, pets, etc., whether the user rents or owns housing, the user's travel destinations, the number of user's with access to the electronic device 12, etc. This and other information may be useful in creating personalized multimedia content specific to each user.

For example, a user that mostly views sporting events may receive targeted multimedia content, including advertising, focused on sports, health foods, sporting events tickets, visiting a sports center, sports related travel, etc. In another example, a user that mostly views movies may receive multimedia content, including advertising, focused on movie previews, exhibitions, encounters with movie stars, movie tickets, movie star fashions, etc. In yet another example, a user that mostly views cooking and travel content may receive targeted multimedia content, including advertising, focused on wines, travels, invitations to food and drink tasting, restaurants, etc. Moreover, users may be offered personalized content in the areas of shopping, real estate, services, health services, announcements and publications, stores, banks and other facilities hours based on the user's geography, whether current or home geography.

The data input by the user and transmitted to or collected by the provider system 24 may include any of a multitude of data, whether explicitly or implicitly input by the user. For example, the data may include information regarding the user's current location to varying degrees of precision using, for example, global positioning system (GPS) data. The data may further include information regarding the user's activity, whether related to the multimedia content provided by the provider system 24 or related to the user's operation of the electronic device 12. The data may further include preferences stated by the user in response to questions posed, activity tracked by the provider system 24 or any other method of collecting user preferences and profiles.

In the solution provided in FIG. 1, the following information may comprise a portion of the data input by the user: activation/deactivation or powering on/off of the electronic device 12; access to any electronic content guides (e.g., interactive television program guide); selections made within any electronic content guides, both general and specific selections (e.g., sports programming—baseball—Chicago White Sox vs. Chicago Cubs); the user's use of any services and resources available through the electronic device 12, including any electronic content guide; what type of content the user selects (e.g., free of additional charge, pay-per-use, etc.); how the selected content is paid for by the user; use of any of the features/functions of the electronic device 12; one or more users' personal profiles, including for example, information input by the user to personalize the multimedia content provided by the provider system 24. The various actions and system conditions can be tracked in real time and can include information regarding the exact date and time of actions, including when the action is initiated and when it is completed/stopped/halted/paused/etc.

Electronic content guides may allow a user to access any of the multimedia content offered by the provider system 24. For example, utilizing the solutions provided herein, a user may use an electronic device 12, such as a television, to access radio and television programs, receive broadcasts of sporting events, news, music concerts, cultural events, public events, access archives and libraries on demand, access internet content, participate in interactive content such as quizzes, lotteries, etc., communicate with other electronic devices 12 using e-mail, short message service communications (sms) instant messaging, telephone, videophone, videoconferencing, internet cameras, interact with security systems, such as home security systems, shop for and purchase products and services, play games, access billing and banking services, etc. Any of these multimedia content provided may be directly provided by the service provider, or it may be accessed using existing communication channels, such as, for example, the internet. The electronic content guides may further enable a user to customize the menus, content, etc. to suit a particular user's preferences. For example, a user may be able to program personalized content, such as, for example, create a personalized television program channel by selecting programs from content available from the provider system 24.

Any combination of the collected data may be used to create a personalized content profile. The personalized content profile may be managed by the user or by the provider system 24. The personalized content profile may be used by the electronic device 12 to decode the multimedia content to provide personalized content to a user. For example, a signal for a television program may include audio programming in English and/or in Spanish. The electronic device 12 may automatically decode the appropriate audio program based on the personalized content profile. In another example, the electronic device may automatically select which audio and/or video signals to decode and output to the user based on the user preferences or profile. The preferences or profiles may include information regarding the user's current, temporary or home location, or any other information gathered through the system 10 as described herein. For example, the electronic device 12 may automatically output to the user programming that most closely matches the user's preferences or profile (e.g., the electronic device 12 may automatically, but with the option to override the automatic selection, display a sporting event to a user that routinely watches sporting events involving the particular team). It is understood that the personalized content profile is a powerful tool that can be used to highly customize multimedia content delivery.

The multimedia content provided via the system 10 can include additional encoded signal layers that may enable additional user interactivity. For example, in the system 10 shown in FIG. 1, a user watching a television program can access additional information about objects in the program (e.g., clothing, furniture, locations, etc.). The user may access the additional information by utilizing the input device 16 (e.g., a touch screen) to select the displayed item. When selected, the system 10 may provide additional information about the selected content, for example, in the case of objects the information may include details regarding the manufacturer, pricing, local and/or mail order merchants, etc., or may even provide the capability of directly ordering the product or service. Similarly, while watching a sporting event, a user may be able to use the input device 16 to choose a camera angle. In yet another example, the additional layers of content may allow the user to choose a language for content delivery. The language preference may result in the receipt of dubbed audio channels, live interpreting, subtitles, etc. In another example, the multimedia content will include additional data, layers, or other information that may be used for any purpose including, for example, security encoding. Any number of signal layers may be utilized for any purpose as permitted by the communication protocol.

The effectiveness of advertising provided through the system 10 may be improved by utilizing the interactive nature of the system 10. For example, a user may participate in a contest at the time of an advertisement transmission. Similarly, a user watching content, such as, for example, a movie may be prompted to find clues located in several advertisements shown during breaks on the movie. Correct identification of the clues may grant the user access to participate in a contest. This type of interactive reward system may be useful in motivating a user to watch attentively to the advertisements.

Using the unique identification data, the system 10 enables a user's programming to follow the user, regardless of geographic location. For example, using IP protocol, personalized television content can be accessed at any place in the world as long as the user provides the proper unique identification data. The unique identification data may be stored, for example, in smart phone, the smart phone may communicate with television using wireless communication technology and the television may then provide personalized multimedia content despite user being presently located across the globe from the user's primary television.

As will be appreciated by understanding of the solutions provided herein, the system 10 may be utilized by the provider system 24 to monitor users and user activity. For example, implementations of the system 10 wherein the electronic device or devices 12 are strategically placed cameras enables the system 10 to be used to gather information regarding traffic conditions, landscapes, entertainment spots, etc.

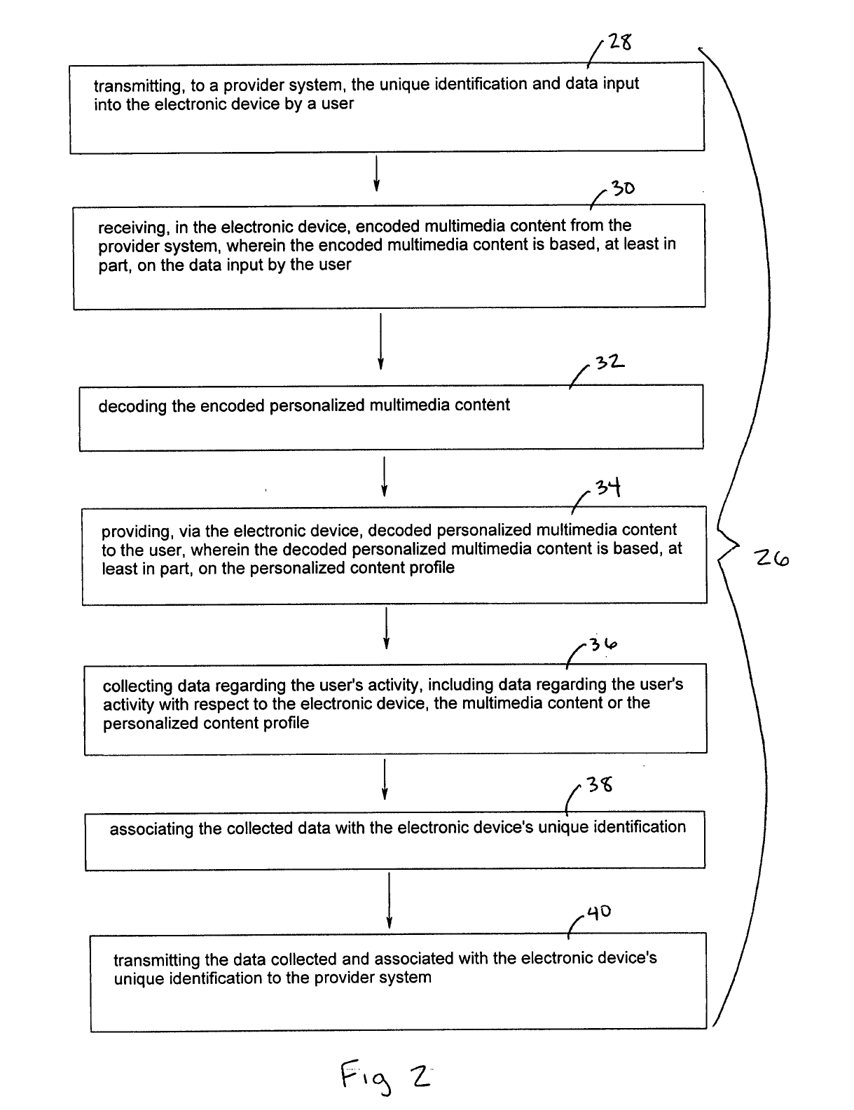

FIG. 2 illustrates an example of a method 26 for providing interactive multimedia content via an electronic device having a unique identification and an personalized content profile associated therewith. The method 26 may be embodied in the system 10 described above with respect to FIG. 1. Accordingly, the description provided above with respect to the system 10, is applicable to the method 26 described herein. The first step 28 shown in FIG. 2 is transmitting, to a provider system 24, the unique identification and data input into the electronic device 12 by a user. The second step 30 shown in FIG. 2 is receiving, in the electronic device 12, encoded multimedia content from the provider system 24, wherein the encoded multimedia content is based, at least in part, on the data input by the user. The third step 32 shown in FIG. 2 is decoding the encoded personalized multimedia content. The fourth step 34 shown in FIG. 2 is providing, via the electronic device 12, decoded personalized multimedia content to the user, wherein the decoded personalized multimedia content is based, at least in part, on the personalized content profile. The fifth step 36 shown in FIG. 2 is collecting data regarding the user's activity, including data regarding the user's activity with respect to the electronic device 12, the multimedia content or the personalized content profile. The sixth step 38 shown in FIG. 2 is associating the collected data with the electronic device's unique identification. The seventh step 40 shown in FIG. 2 is transmitting the data collected and associated with the electronic device's unique identification to the provider system 24.

As shown by the above description, aspects of the system for providing interactive multimedia content 10 are controlled by the controller 14. Typically, the controller 14 is implemented by one or more programmable data processing devices. The hardware elements operating systems and programming languages of such devices are conventional in nature, and it is presumed that those skilled in the art are adequately familiar therewith. Accordingly, any device that may be used to perform the functions described herein with respect to the controller 14 may be substituted for the controllers 14 described in the examples above. For example, in some instances the functions of the controller 14 may be embodied in programmable instructions, for example, on a CD-ROM, a flash drive or any other memory.

For example, the controller 14 may be a microprocessor in a portable electronic device, such as, for example, a cellular phone, a personal digital assistant, a audio/video playing device, etc. These systems including microprocessors are referred to generically herein as computer systems. In another example, the controller maybe a PC based implementation of a central control processing system. The PC based system contains a central processing unit (CPU), memories and an interconnect bus. The CPU may contain a single microprocessor (e.g. a Pentium microprocessor), or it may contain a plurality of microprocessors for configuring the CPU as a multi-processor system. The other components of the computer system described above include memories, including a main memory, such as a dynamic random access memory (DRAM) and cache, as well as a read only memory, such as a PROM, an EPROM, a FLASH-EPROM, or the like. The system also includes mass storage devices such as various disk drives, tape drives, etc. In operation, the main memory stores at least portions of instructions for execution by the CPU and data for processing in accord with the executed instructions.

The mass storage may include one or more magnetic disk or tape drives or optical disk drives, for storing data and instructions for use by CPU. For example, at least one mass storage system in the form of a disk drive or tape drive, stores the operating system and various application software as well as data. The mass storage within the computer system may also include one or more drives for various portable media, such as a floppy disk, a compact disc read only memory (CD-ROM), or an integrated circuit non-volatile memory adapter (i.e. PC-MCIA adapter) to input and output data and code to and from the computer system.

The computer system also includes one or more input/output interfaces for communications, shown by way of example as an interface for data communications with one or more processing systems. Although not shown, one or more such interfaces may enable communications via a network, e.g., to enable sending and receiving instructions electronically. The physical communication links may be optical, wired, or wireless.

The computer system may further include appropriate input/output ports for interconnection with a display and a keyboard serving as the respective user interface for the controller 14. For example, the computer system may include a graphics subsystem to drive the output display. The output display, for example, may include a cathode ray tube (CRT) display, or a liquid crystal display (LCD) or other type of display device. Although not shown, a PC type system implementation typically would include a port for connection to a printer. The input control devices for such an implementation of the computer system would include the keyboard for inputting alphanumeric and other key information. The input control devices for the computer system may further include a cursor control device (not shown), such as a mouse, a touchpad, a trackball, stylus, or cursor direction keys. The links of the peripherals to the computer system may be wired connections or use wireless communications.

The computer system runs a variety of applications programs and stores data, enabling one or more interactions via the user interface provided, and/or over a network to implement the desired processing.

The components contained in the system 10 are those typically found in general purpose computer systems. Although illustrated as a PC type device, those skilled in the art will recognize that the class of applicable computer systems also encompasses systems used as servers, workstations, network terminals, and the like. In fact, these components are intended to represent a broad category of such computer components that are well known in the art.

A software or program product may take the form of code or executable instructions for causing a computer or other programmable equipment to perform the relevant data processing steps, where the code or instructions are carried by or otherwise embodied in a medium readable by a computer or other machine. Instructions or code for implementing such operations may be in the form of computer instruction in any form (e.g., source code, object code, interpreted code, etc.) stored in or carried by any readable medium.

Terms relating to computer or machine “readable medium” that may embody programming refer to any medium that participates in providing code or instructions to a processor for execution. Such a medium may take many forms, including but not limited to non-volatile media, volatile media, and transmission media. Non-volatile media include, for example, optical or magnetic disks, such as any of the storage devices in the computer system. Volatile media include dynamic memory, such as main memory. Transmission media include coaxial cables; copper wire and fiber optics including the wires that comprise a bus within a computer system. Transmission media can also take the form of electric or electromagnetic signals, or acoustic or light waves such as those generated during radio frequency or infrared data communications. In addition to storing programming in one or more data processing elements, various forms of computer readable media may be involved in carrying one or more sequences of one or more instructions to a processor for execution, for example, to install appropriate software in a system intended to serve as the controller 14.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. An electronic device for providing multimedia content to a user, the electronic device having a unique identification and a personalized content profile associated therewith, the electronic device comprising:
an input device adapted to receive data input by the user;
a transmitter adapted to transmit data to a provider system including the data input by the user, the data being associated with the device's unique identification;
a receiver adapted to receive encoded multimedia content from the provider system, wherein the transmitter and receiver enable the electronic device to receive the encoded multimedia content from the provider system while concurrently transmitting the data input by the user to the provider system;
an output device adapted to output decoded multimedia content; and
one or more controllers controlling the operation of the input device, the transmitter, the receiver and the output device, wherein the one or more controllers decode the encoded multimedia content and output the decoded multimedia content through the output device, wherein the decoding and output is based, at least in part, on the device's personalized content profile.

2. The electronic device of claim 1 wherein the input device receives data actively input by the user.

3. The electronic device of claim 1 wherein the input device receives data passively input by the user.

4. The electronic device of claim 1 wherein the transmitter and receiver communicate using Internet Protocol.

5. The electronic device of claim 1 wherein the encoded multimedia content includes audio data, visual data and additional data that is neither audio nor visual data.

6. The electronic device of claim 5 wherein the additional data is used for security encryption.

7. The electronic device of claim 1 wherein the unique identifier is associated with a plurality of personalized content profiles.

8. The electronic device of claim 7 wherein any the plurality of content profiles may be selected for use using the input device.

9. The electronic device of claim 1 wherein the personalized content profile is managed by the provider system.

10. The electronic device of claim 1 wherein the personalized content profile is managed by the one or more controllers.

11. A computer-readable medium having computer-executable instructions for providing interactive multimedia content via an electronic device having a unique identification and an personalized content profile associated therewith, the computer-executable instructions performing the steps of:
transmitting, to a provider system, the unique identification and data input into the electronic device by a user;
receiving, in the electronic device, encoded multimedia content from the provider system, wherein the encoded multimedia content is based, at least in part, on the data input by the user;
decoding the encoded personalized multimedia content;
providing, via the electronic device, decoded personalized multimedia content to the user, wherein the decoded personalized multimedia content is based, at least in part, on the personalized content profile;
collecting data regarding the user's activity, including data regarding the user's activity with respect to the electronic device, the multimedia content or the personalized content profile;
associating the collected data with the electronic device's unique identification; and
transmitting the data collected and associated with the electronic device's unique identification to the provider system.

12. The computer-readable medium of claim 8, wherein the computer executable is embodied in a microprocessor.

13. The computer-readable medium of claim 8, wherein the computer executable is embodied in portable media.

14. The computer-readable medium of claim 8, wherein the unique identification and data input into the electronic device by a user is transmitted via Internet Protocol.

15. The computer-readable medium of claim 8, wherein decoding the encoded personalized multimedia content includes decoding security data.

16. The computer-readable medium of claim 8, wherein the personalized content profile is based, at least in part, on data passively input into the electronic device by the user.

17. The computer-readable medium of claim 8, wherein the electronic device is a television.

18. A method of providing interactive multimedia content via an electronic device having a unique identification and an personalized content profile associated therewith, the method comprising the steps of:
transmitting, to a provider system, the unique identification and data input into the electronic device by a user;
receiving, in the electronic device, encoded multimedia content from the provider system, wherein the encoded multimedia content is based, at least in part, on the data input by the user;
decoding the encoded personalized multimedia content;
providing, via the electronic device, decoded personalized multimedia content to the user, wherein the decoded personalized multimedia content is based, at least in part, on the personalized content profile;
collecting data regarding the user's activity, including data regarding the user's activity with respect to the electronic device, the multimedia content or the personalized content profile;
associating the collected data with the electronic device's unique identification; and
transmitting the data collected and associated with the electronic device's unique identification to the provider system.

19. The method of claim 18 wherein the method is executed by the electronic device.

20. The method of claim 19 wherein the electronic device includes computer-executable instructions performing the steps of the method.
